(19) United States
(12) Patent Application Publication
(10) Pub. No.: US 2021/0283844 A1
(43) Pub. Date: Sep. 16, 2021

(54) RETRACTABLE OPTICAL BARRIER FOR FIXED OVER HEAD LAMP SYSTEM

(71) Applicant: HEWLETT-PACKARD DEVELOPMENT COMPANY, L.P., Spring, TX (US)

(72) Inventors: Alvin POST, Vancouver, WA (US); Brent EWALD, Vancover, WA (US)

(21) Appl. No.: 16/608,348

(22) PCT Filed: Jan. 31, 2018
(86) PCT No.: PCT/US2018/016120

§ 371 Date: Oct. 25, 2019

(51) Int. Cl. B29C 64/286; B33Y 30/00; B22F 12/44; B22F 12/63; B29C 64/218

(52) U.S. Cl. CPC B29C 64/286; B33Y 30/00; B29C 64/218; B22F 12/63; B22F 12/44

(57) ABSTRACT

A retractable shade disposed between build material and a lamp facilitates uniform thermal processing across the length of a build bed by blocking emitted radiation from the lamp during movement of the pen across the build bed.

### BACKGROUND

During additive manufacturing, print head technology may be used to print a liquid fusing agent onto a formed layer of build material. The process may be repeated, layer by layer, to form a three-dimensional (3D) part. The fusing agent may be applied using a pen device comprising one or multiple print heads on a printing carriage which can move in a scan axis from one side of the print zone, printer bed, or build bed, to the other side. Moving along the carriage, the pen may have a printer head aligned in an orthogonal way related to the scan axis. In this manner, the printer may print over the entire printer bed surface in a single pass of the printhead over the surface. A fusing lamp applies heat to the powder layer causing the portions of the build powder on which a fusing agent was applied to heat up, melt, and fuse. The printer may also have a warming lamp to maintain the build material at a desired temperature prior to fusing.

Such printers may fuse the build material using fixed overhead (FOH) lamps, which do not move, or scanning lamps, which move over the build material across a print zone or build bed. For such printers, the FOH lamps may offer better performance at lower power than scanning lamp designs. With FOH systems, some process cycle designs automatically provide uniform radiant fusing energy across the length of the build bed. Other process cycle designs result in different heating intervals at each end of the build bed, causing performance to vary. For example, a variation in the heating intervals may cause non-uniform fusing, which may affect the strength or shrinkage of the 3D part.

Some printers use moving lamps to fuse parts. This works, but fusing with FOH lamps may deliver a 35% power savings and other advantages over moving lamps. FOH systems heat the bed uniformly across its length with some process designs. Other process designs may offer certain benefits, but may result in a heating difference across the length of the bed. For example, two powder spreading passes per cycle may improve part surface quality, but would cause such a heating difference.

Varying the process speed across the bed does not actually resolve thermal processing disparities. Varying lamp output during the build cycle is not a good solution because the time constant of the lamps is too long, and because it introduces power fluctuations that may be prohibited.

### BRIEF DESCRIPTION OF THE DRAWINGS

Certain examples are described in the following detailed description and in reference to the drawings, in which:

FIG. 1 is a simplified diagram of an apparatus having a retractable cover, according to examples.

FIGS. 2A-2E are simplified diagrams used to illustrate how non-uniform warming or fusing of build material may occur, according to examples.

FIGS. 3A-3E depict the apparatus of FIGS. 2A-2E, including the cover of FIG. 1, according to examples.

FIGS. 4A-4D illustrate four scenarios in which the cover of FIG. 1 is attached to another device of an additive manufacturing assembly, according to examples.

FIG. 5 is a simplified diagram of an additive manufacturing assembly featuring the retractable cover of FIG. 1, according to examples.

FIG. 6 is an illustration of the retractable cover of FIG. 1 attached to both a pen and a spreader, according to examples.

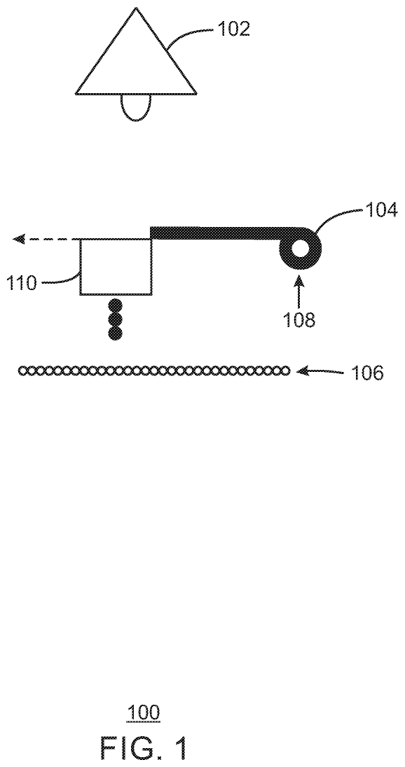

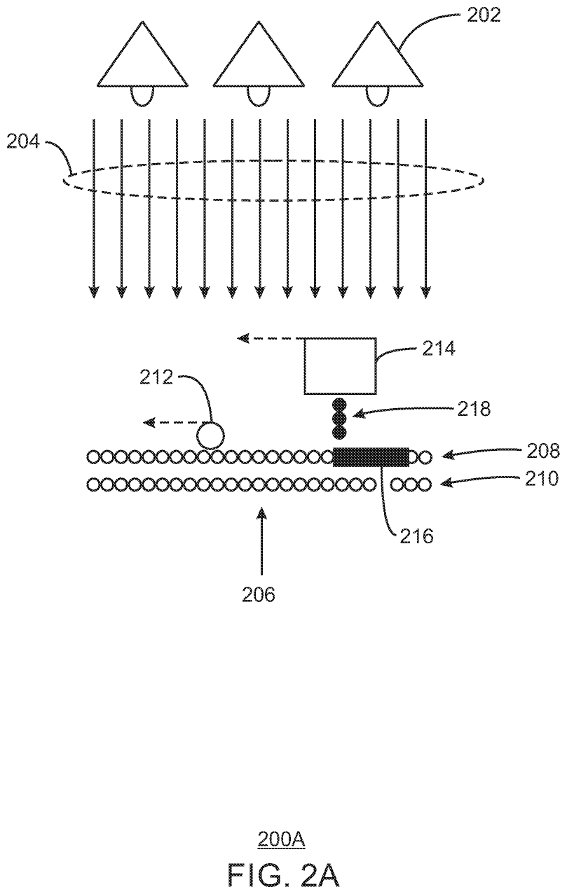

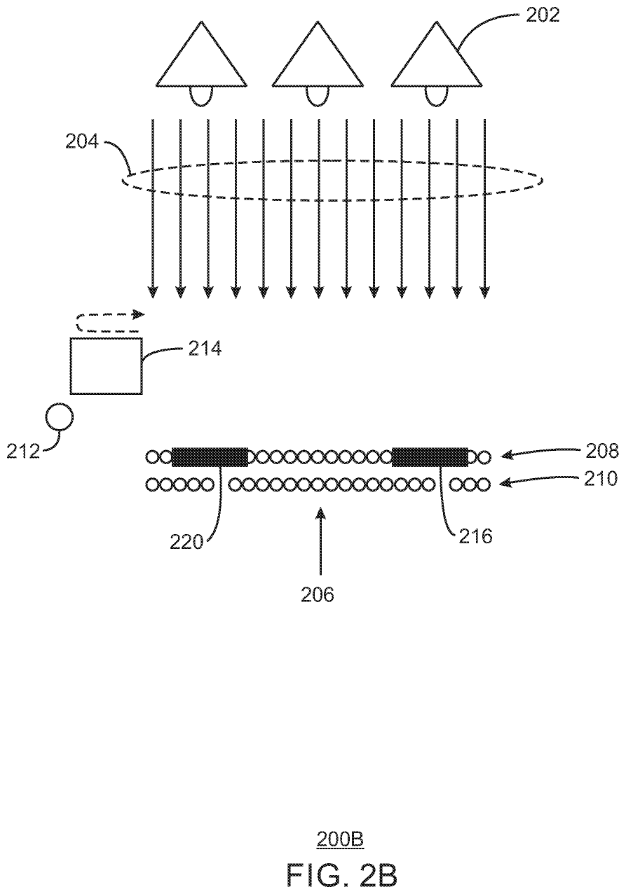

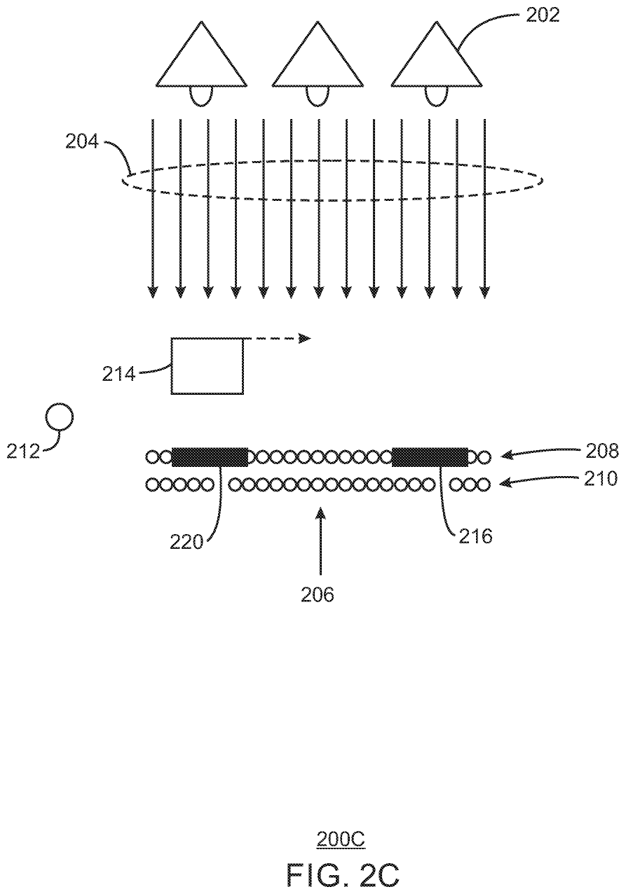

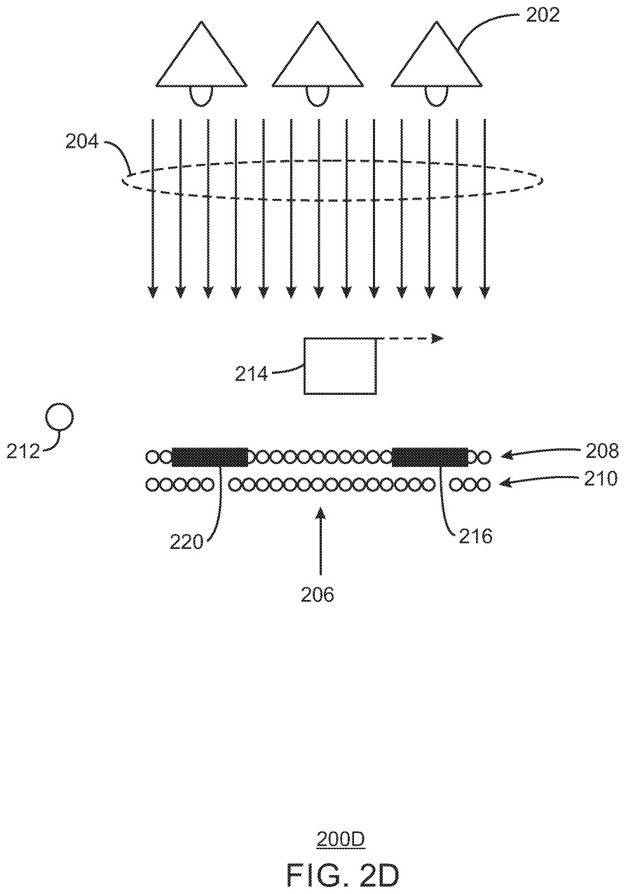

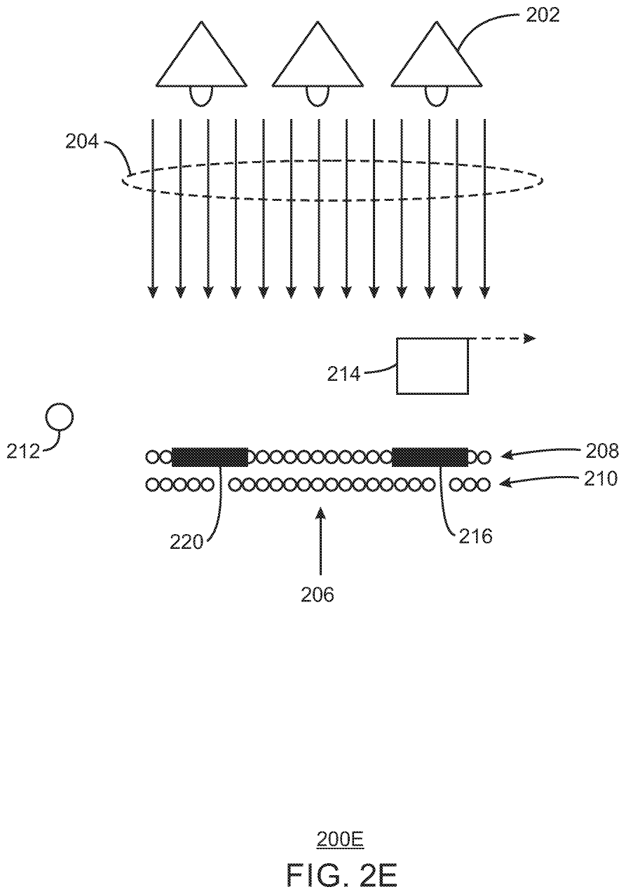

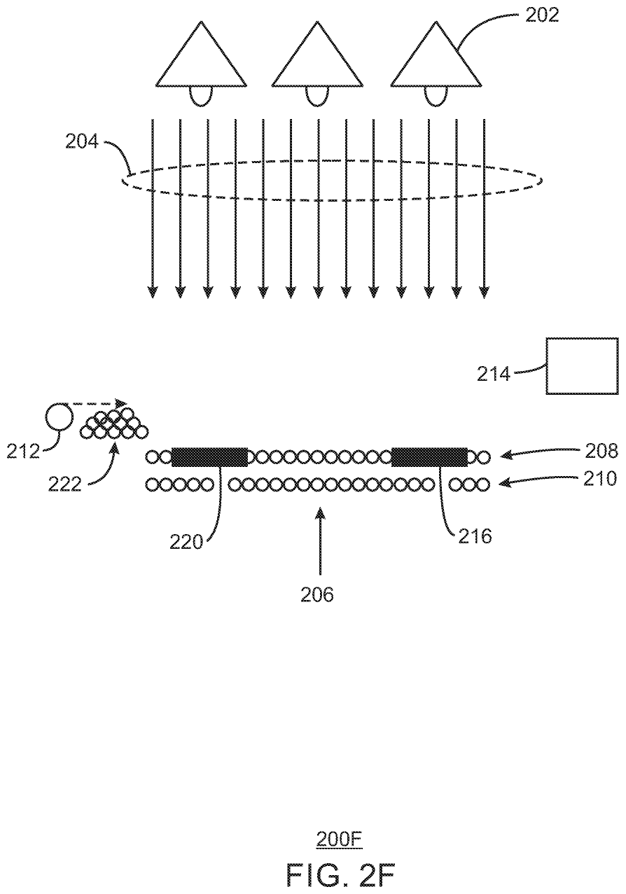

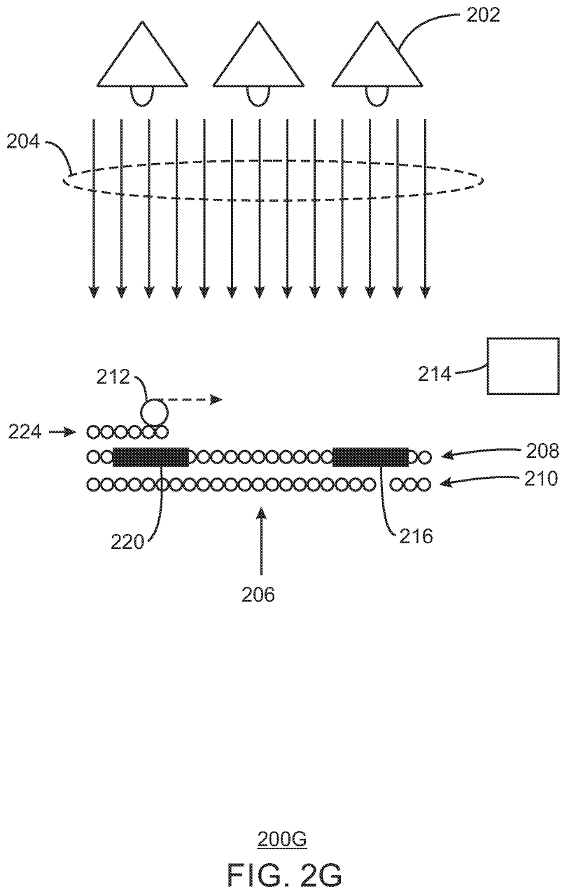

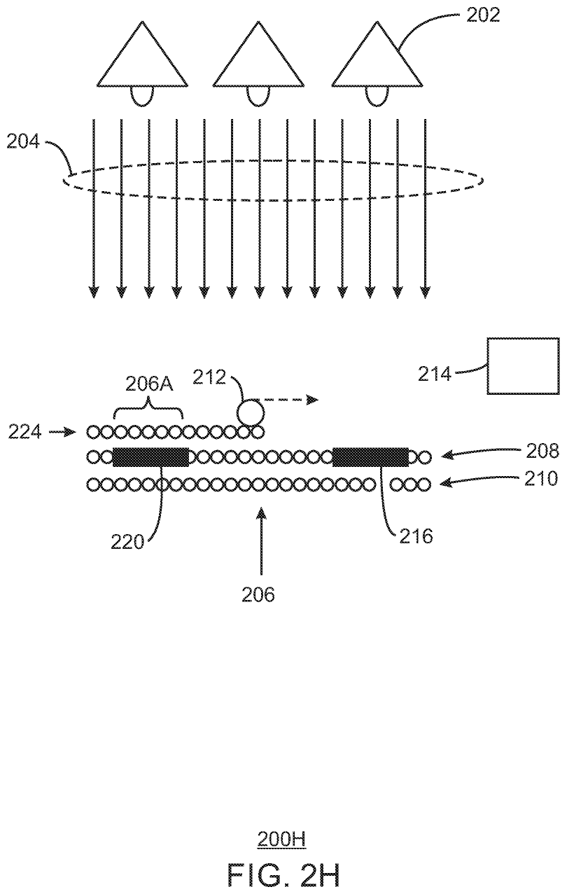

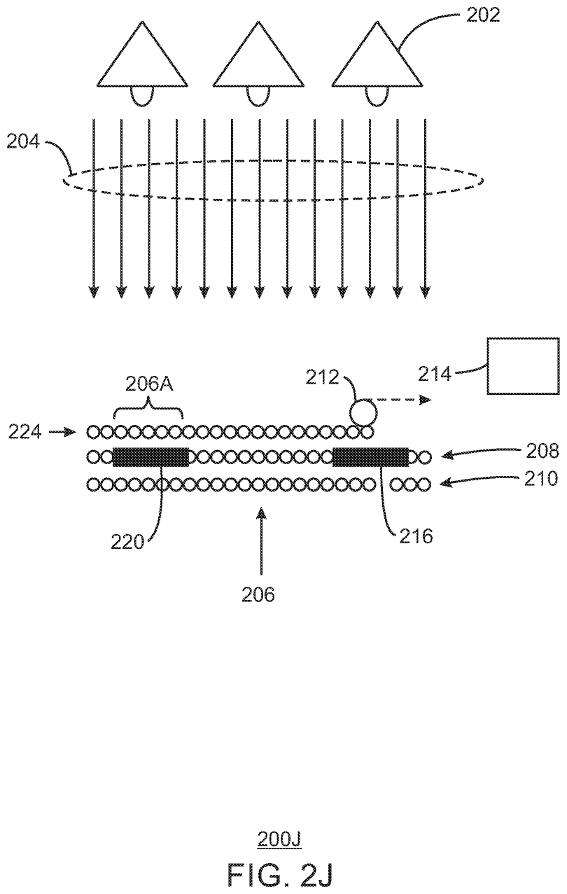

The same numbers are used throughout the disclosure and the figures to reference like components and features. Numbers in the 100 series refer to features originally found in FIG. 1, numbers in the 200 series refer to features originally found in FIG. 2, and so on.

### DETAILED DESCRIPTION

In accordance with the examples described herein, a retractable shade is disclosed to mitigate variations in heating of build material for an additive manufacturing printer. Disposed between a warming or fusing lamp and build material, the retractable shade may be opened or closed in a fashion similar to a retractable window shade. The retractable shade may be connected to a spreader roller, a pen, or both, automatically opening and closing as the spreader roller/pen is moved. Or, the retractable shade may be detached from the spreader roller or pen and separately activated. The retractable shade provides uniform thermal processing across the build material of a 3D printer using fixed overhead lamps.

FIG. 1 is a simplified diagram of an apparatus 100 having a retractable shade, cover, or shield 104, according to some examples. The retractable and expandable cover 104 is designed to block or reduce light emissions for a period of time (or for a portion of the layer processing cycle) from one or more lamps from reaching build material, so as to promote uniform distribution of the emissions. The apparatus 100 may be an additive manufacturing printer used to build three-dimensional (3D) parts. The retractable shade 104 is disposed between a lamp 102 and build material 106 and is coupled to a pen 110, which facilitates its expansion and retraction.

In some examples, the lamp 102 is a fixed overhead (FOH) lamp that does not move. The lamp 102 may be a warming lamp to maintain the build material 106 at a desired temperature. Warming lamps generally maintain the build material at a temperature close to, but below, the melting point of the build material; thus, the warming lamps do not fuse the build material. This reduces the amount of energy needed by the fusing lamps during subsequent fusing. The lamp 102 may be a fusing lamp meant to fuse material, such as the build material 106, upon which a liquid fusing agent has been applied.

Coupled to the moving pen 110, the retractable shade 104 covers the build material 106 so as to block the light emitted from the lamp 102 from reaching the build material. The retractable shade 104 comprises a sheet of material 112 that is, in the example of FIG. 1, wrapped around a spool 108. The spool 108 may be activated by a motor (not shown). The spool 108 provides an anchor for the shade material 112. In some examples, the spool 108 is disposed outside a build bed.

In some examples, the shade material 112 is made from a material that absorbs light. In other examples, the shade material 112 is made of a reflecting material. In still other examples, the shade material 112 is absorptive on its top surface (near the lamp 102) and reflective on its bottom surface (near the build material 106). In still other examples, the shade material 112 is perforated to allow some light to pass through the retractable shade 104.

The build material 106 may be a powder, such as a plastic powder, or a powder-type material, or a metal powder having small particle sizes, where the particle size (particle diameter) is chosen to suit process and manufacturing concerns. For example, the build material 106 may be a polymer, such as PA12, which has an approximate particle diameter of 60 microns. Another powder material, known as PA11, is more heterogeneous than PA12 and has diameters between 10 and 15 microns. The build material 106 may also be a metal, such as iron, chromium, or titanium, a plastic resin, a wax, or any other type of material that can be reduced to a powder form. The build material 106 may have a detailing agent applied to it, such as ink, a binding agent, or a fusing agent. The principles described herein may apply to a variety of materials, particle sizes, types of agents to be combined with the materials, and so on.

During an additive manufacturing build, build material may be deposited upon a build bed and spread across the surface evenly. Thus, a moving spreader device may be part of the apparatus. A pen comprising ink jets to deposit a print agent, such as a fusing agent, upon the build material may also be part of the apparatus. Thus, between the lamp 102 and the build material 106, there may be several mechanisms that may interrupt light from the lamp 102.

Some printers use moving (scanning) lamps to fuse parts. Fusing with fixed overhead lamps (FOH) can deliver important power savings and other advantages. In some examples, the disclosed retractable shade is used with FOH lamps.

FIGS. 2A-2J are simplified diagrams used to illustrate how non-uniform warming of build material may occur, according to examples. FIGS. 2A-2J illustrate successive time periods for a hypothetical additive manufacturing printer, with 200A being a first point in time, 200B being a second, later, point in time, and so on, until 200J, which is a final time period in the succession (there is no time period 200I).

In the first time period 200A (FIG. 2A), a lamp assembly 202, comprising three lamps in this example, is emitting radiant energy or heat 204 toward two layers of build material 208, 210, each layer comprising build material 206. A powder spreader 212, a pen 214, and a part 216 are also depicted. Although the lamp assembly 202 is used for fusing, some applications of the retractable shade may be useful for warming lamp configurations as well.

The powder spreader 212 spreads powder 206 so as to form relatively uniform layers 208 and 210 of powder. In the example of FIG. 2A, the powder spreader 212 is moving to the left on its second pass over the powder layer 208, having already moved to the right, for a first-pass spread of the build material 206 forming layer 208 (not shown), with the direction of the second pass being indicated by the dashed arrow.

Also moving in a leftward direction in FIG. 2A, the pen 214 includes one or more ink-jet heads, which selectively deposit a liquid material 218, such as a binder or ink, to a formed layer of powder below the pen. Heat from the lamp assembly 202 facilitates the liquid material 218 combining with powder 206 at those locations such that the materials fuse into the part 216. In the first time period of FIG. 2A, some of the radiant energy 204 is blocked by the pen 214 from reaching the part 216.

In a second time period 200B (FIG. 2B), the powder spreader 212 and the pen 214 have moved leftward and are now parked to the left of the powder layers 208 and 210. A second part 220 is also shown, having been formed in the previous time period 200 by the pen 214 depositing liquid material over build material at that location. Both the powder spreader 212 and the pen 214 are immobile at this point.

At the time period 200B, the distribution of radiant energy 204 to parts 216 and 220 is somewhat uniform. The lamp assembly 202 is emitting radiant energy 204 toward the layer 208 having parts 220 and 216 thereon. Already, between time period 200A (FIG. 2A) and time period 200B (FIG. 2B), the part 216 has received more radiant energy 204 than the just formed part 220. A u-turn arrow above the pen 214 is meant to illustrate its path across the build material, first in a leftward direction (FIG. 2A), then in a rightward direction.

FIGS. 2C-2E illustrates a third, fourth, and fifth time periods 200C, 200D, and 200E, respectively, of the hypothetical printer, in which the pen 214 is moving to the right over the layers 208, 210 of build material 206, as well as the parts 216, 220. In these time periods, the pen 214 is performing no deposition operation, but is returning to a position to the right of the layers 208, 210. The pen 214 blocks radiant energy 204 over the part 220 in time period 200C, does not block radiant energy over either part 220 or 216 in time period 200D, and blocks radiant energy over the part 216 in time period 200D. Assuming a relatively uniform speed of the movement from left to right of the pen 214, the blocking time period for parts 220 (FIG. 2C) and 216 (FIG. 2E) are about the same, in examples. Nevertheless, the pen 214 is blocking radiant energy 204 from reaching the parts 216 and 220 as the pen moves over the parts. The powder spreader 212 is not moving during these time periods 200C, 200D, and 200E, and is disposed stationary to the left of the build layers.

FIG. 2F illustrates a next time period 200F, featuring a deposit of build material 222 to be spread over the layer 208 of build material by the powder spreader 212. With a rightward movement of the powder spreader 212, the build material 222 will form a third layer 224 of build material (FIG. 2G). In time period 200F, the powder spreader 212 is to the left of the layers 208 and 210 while the pen 214 is to their right. Thus, neither device is blocking the radiant energy 204 being transmitted by the lamp assembly 202.

FIGS. 2G, 2H, and 2J depict time periods 200G, 200H, and 200J, respectively, in which the powder spreader 212 is moving in a rightward direction, spreading the build material 222 (FIG. 2F) over the build layer 208 and forming build layer 224. In the time period 200G, the powder spreader 212 is disposed over the part 220; thus, the part 220 is receiving less radiant energy 204 than the part 216.

In FIG. 2H, the final time period 200H for the hypothetical printer is considered. The powder spreader 212 is continuing to move rightward in creating the build layer 224. Build material 206A of the build layer 208 may be a location for deposition of liquid material 218 (FIG. 2A), for example, if formation of the part 220 is not yet complete. As in the time period 200G (FIG. 2G), in the time period 200H, the part 216 is receiving more radiant energy 204 than the part 220, as the part 220 is blocked by the build layer 224.

In FIG. 2J, the final time period 200J for the hypothetical printer is considered. The powder spreader 212 is continuing to move rightward in creating the build layer 224. Both parts 220 and 216 are being blocked, the former by the freshly spread powder for the next layer 206A and the latter by the powder spreader 212.

What the illustrations of time periods 200A-200J show is that the part 216 is exposed to more radiant energy 204 from the lamp assembly 202 than the part 220. In FIG. 2A, radiant energy 204 is blocked to the part 216, but at the time period 200A, there is no part 220 for comparison. Otherwise, radiant energy 204 blocks part 216 two other times (time periods 200E and 200J). Part 220, which was created in a time period later than part 216, experiences blocking of the radiant energy 204 more times than part 216 (time periods 200C, 200G, 200H, 200J). Thus, there is an imbalance of radiant energy being received by the two parts 216 and 220, and part 220 thus receives less radiant energy than part 216.

These scenarios may be addressed by using an extendable and retractable cover, such as the retractable shade 104 of FIG. 1. In some examples, the retractable shade 104 is similar to a pull-down window shade, attached on one end and anchored outside the build material area, such as a build bed. In some examples, one end of the retractable shade 104 is attached to a moveable spreader roller, to a pen, or to both devices.

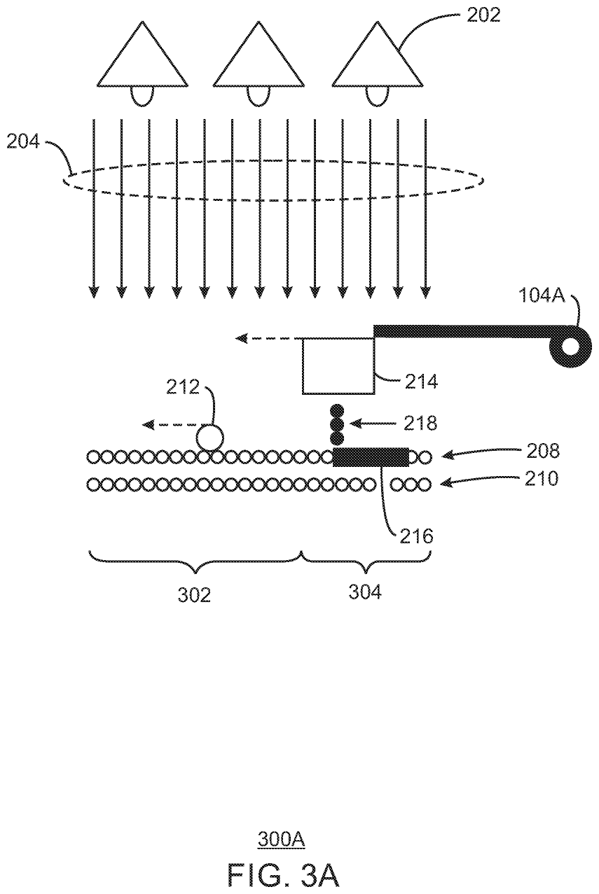

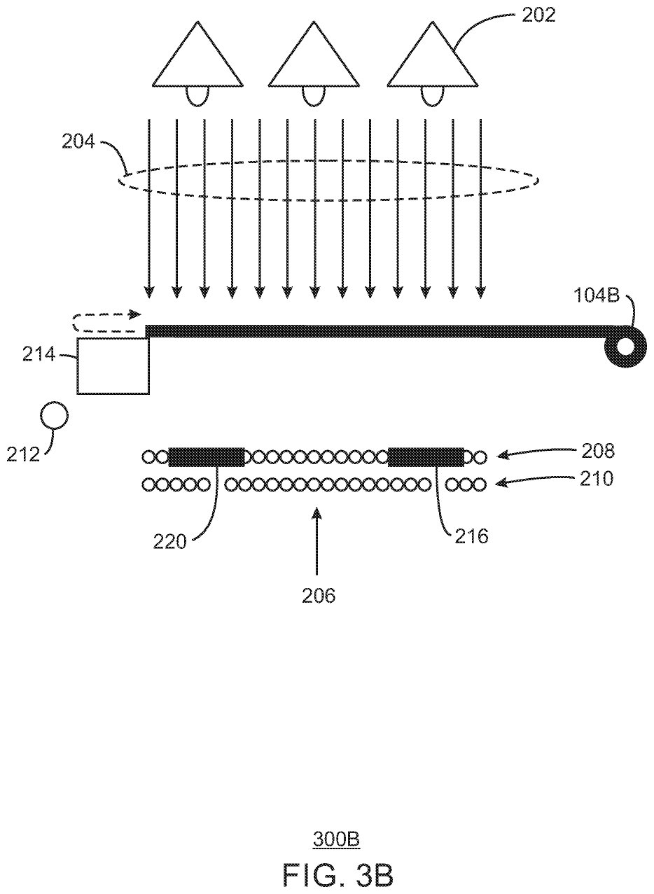

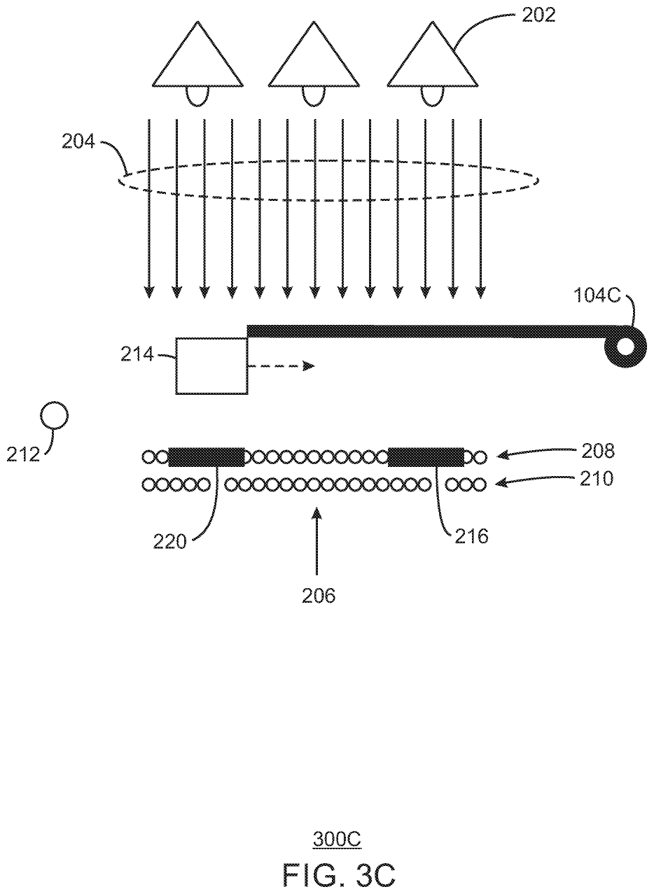

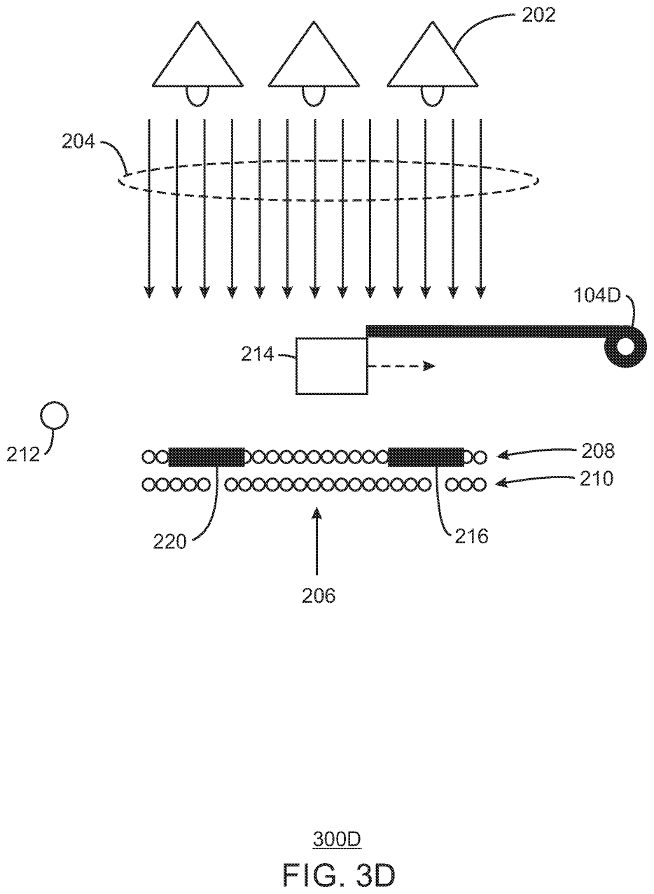

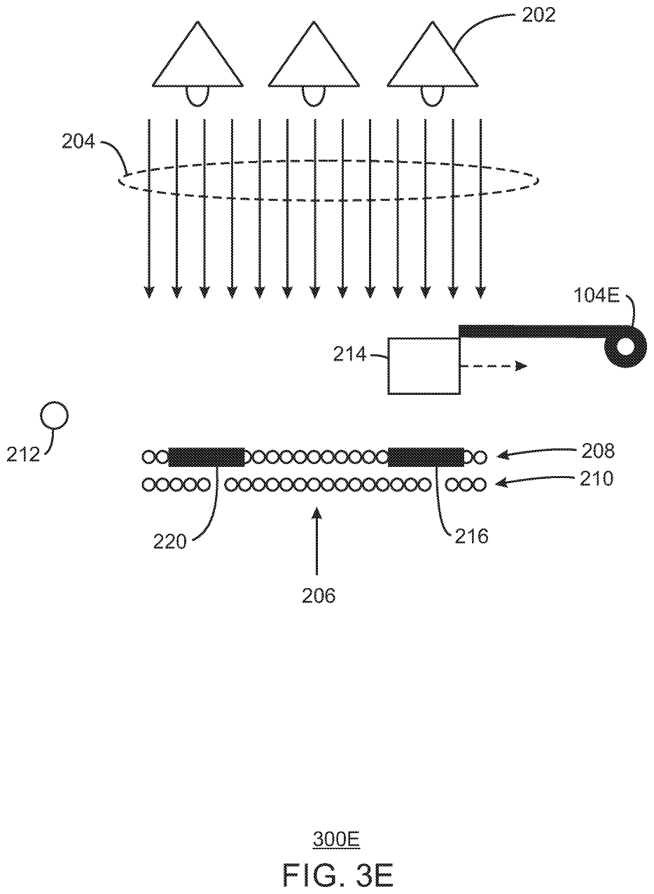

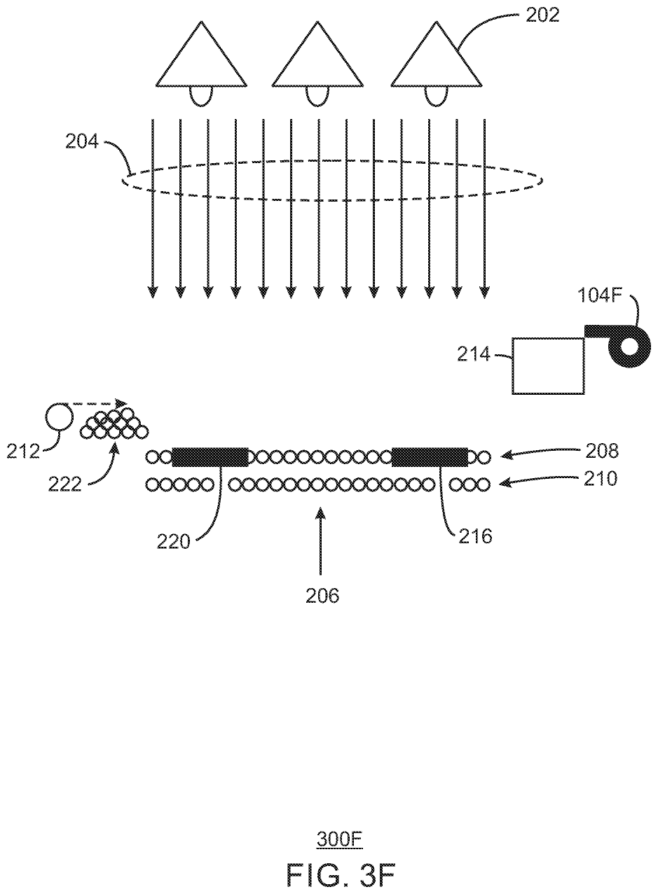

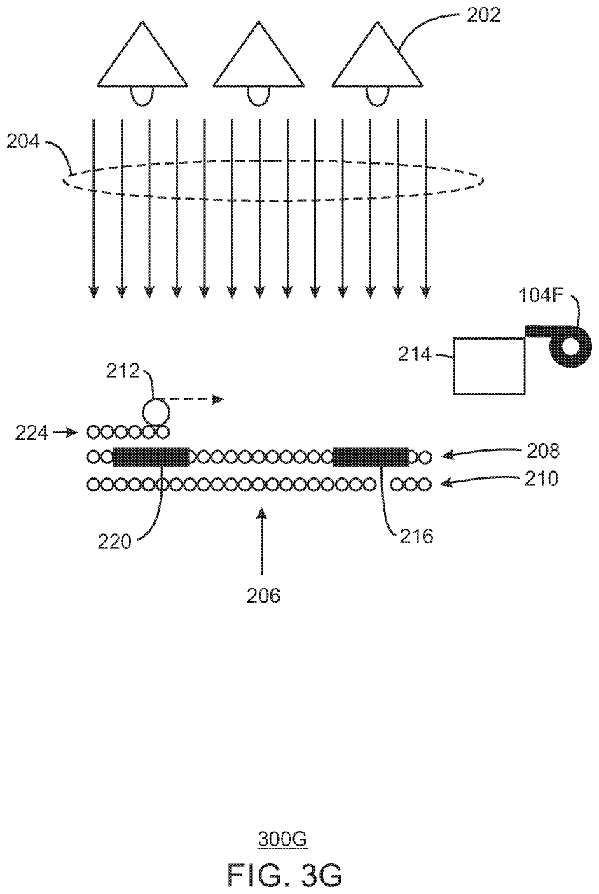

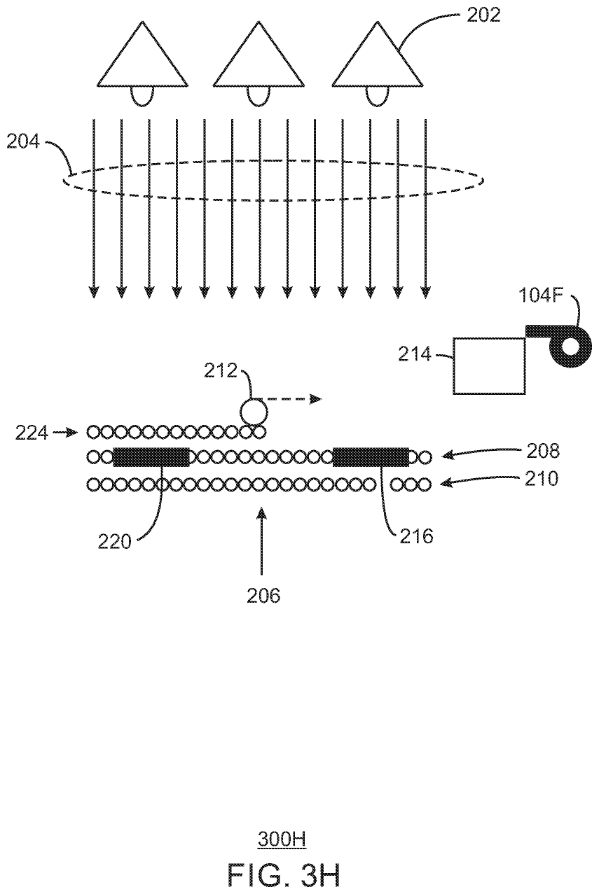

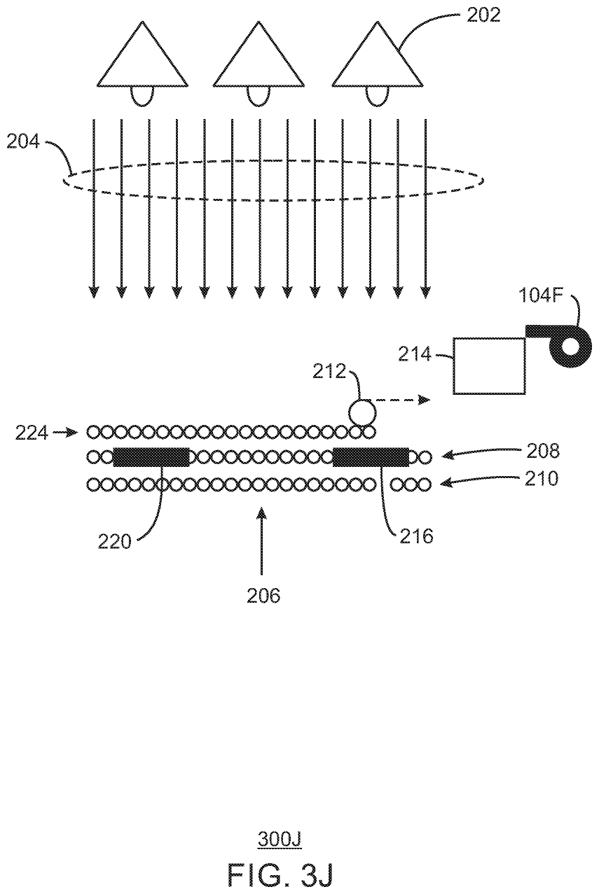

FIGS. 3A-3J depict the time periods of FIGS. 2A-2J for hypothetical printer, this time with the retractable and extendable cover 104, according to some examples. In these examples, the cover 104 is fixably attached to the upper right corner of the pen 214. In alternative examples, the cover 104 may be attached to the upper left corner of the pen, thus covering both the pen and the build material, as illustrated in FIG. 4, below.

In FIG. 3A, the time period 300A shows the lamp assembly 202 emitting radiant energy 204 toward build layers 208 and 210. In this example, the cover 104 is partially expanded as cover 104A to cover the portion of build material disposed to the right of the pen 214. Along with the pen itself, build material beneath and to the right of the pen 214, denoted build material 304, are blocked from receiving the radiant energy 204 while build material to the left of the pen, build material 302, are not blocked. Thus, during the deposition of printing liquid 218, the part 216 is blocked from receiving radiant energy 204. The powder spreader 212, disposed to the left of the pen 214, is also moving in a leftward direction.

In FIG. 3B, the second part 220 has been formed and the pen 214 is disposed to the left of the build layers 208 and 210, with the cover, denoted 104B, being more fully expanded (relative to cover 104A in FIG. 3A), as the pen 214 moves leftward across the build layers 208 and 210. Because the cover 104B blocks radiant energy 204 during the leftward movement of the pen 214, radiant energy 204 is blocked for both the part 216 and the recently formed new part 220.

In FIGS. 3C-3E, time periods 300C, 300D, and 300E, respectively, show the pen 214 moving in a rightward direction, similar to what is shown in FIGS. 2C-2E, above. In FIG. 3C, the pen 214 is blocking radiant energy 204 from reaching the part 220, and part 216 is blocked from receiving radiant energy by cover 104C. Thus, both parts 220 and 216 are being blocked. In FIG. 3D, the cover 104D is blocking the part 216 from receiving radiant energy 204 but not the part 220. Thus, the part 220 is fused by the radiant energy at this stage. In FIG. 3E, the pen 214 is blocking radiant energy 204 from reaching the part 220.

In FIGS. 3F-3J, time periods 300F, 300G, 300H, and 300J, respectively, show the pen 214, and thus the retractable shade cover 104F, in a stationary position to the right of the build layers 208 and 210. Because the cover 104F is not moving, there is no difference in receipt of radiant energy 204 for the parts 220 and 216 in these time periods. Additional build material 222 is shown will form build layer 224 by rightward movement of the powder spreader 212, as described above. For time period 300G (FIG. 3G), the build material 222 and the powder spreader 212 block radiant energy 204 from being received by the part 220 but no blockage of radiant energy to the part 216 occurs. For time period 300H (FIG. 3H), the part 220 is still blocked from receiving radiant energy 204 while the part 216 is not. For time period 300J, both parts 220 and 216 are blocked from receiving radiant energy 204 by the powder layer 224.

Table 1 compares the operations of FIGS. 2A-2J, in which no blocking of radiant energy from the lamp assembly 102 occurs, with those of FIGS. 3A-3J, which includes the retractable shade cover 104. Table 1 answers, with yes (Y) and no (N) answers the following question: Is the part (either the left part 220 or the right part 216) receiving radiant energy from the lamp assembly.

TABLE 1
Comparison with and without retractable shade cover

| FIG. | left | right | FIG. | left | right | action |
|---|---|---|---|---|---|---|
| 2A | n/a | Y | 3A | n/a | N | pen moving left |
| 2B | Y | Y | 3B | N | N | pen moving left |
| 2C | N | Y | 3C | N | N | pen moving right |
| 2D | Y | Y | 3D | Y | N | pen moving right |
| 2E | Y | N | 3E | Y | N | pen moving right |
| 2F | Y | Y | 3F | Y | Y | no movement |
| 2G | N | Y | 3G | N | Y | spreader moving right |
| 2H | N | Y | 3H | N | Y | spreader moving right |
| 2J | N | N | 3J | N | N | spreader moving right |
| total Y: | 4 | 7 | total Y: | 3 | 3 | |

Table 1 shows that the first five comparisons, between FIGS. 2A and 3A, 2B and 3B, . . . , and 2E and 3E are where the differences emerge, namely, during the time the pen is moving to the left, then to the right. By attaching the retractable shade cover to the pen, the differences between receipt of radiant energy by the two parts is substantially solved. Notice that, before the retractable shade cover is used, the left part 220 receives radiant energy four times (see FIGS. 2B and 2D—2F) while the right part 216 receives radiant energy seven times (see FIGS. 2A-2D and 2F-2H). When the retractable shade cover is used, both parts receive the radiant energy three times. According to examples, the retractable shade cover improves the uniform thermal processing of differently positioned parts being manufactured.

FIG. 4 illustrates the retractable shade cover 104G, this time being attached over the pen 214. Because the lamp assembly 202 is sending radiant energy downward, components beneath the lamps may heat up, and this includes the pen. The print heads of the pen are designed to not exceed a certain temperature. By having the retractable shade cover disposed over the pen, as in FIG. 4, the cover can block radiant energy to the pen, thus providing an additional benefit.

For example, the retractable shade cover may be made using a flexible optical filter material or a polarizing material, so as to allow some but not all wavelengths of the radiant energy to reach the parts. In an example, as a mechanical solution, the retractable shade cover disclosed herein is an improvement over strategically turning the lamp assembly on and off, which may cause flickering or other power issues.

For process operations that are different than illustrated in FIGS. 2A-2J and 3A-3J, the retractable shade cover may be attached to the spreader roller, and thus be expanded and contracted in accordance with the movement of the spreader roller. In other examples, the retractable shade cover may have its own mechanism for contracting and expanding that takes place without consideration of the movement of the spreader roller or the pen.

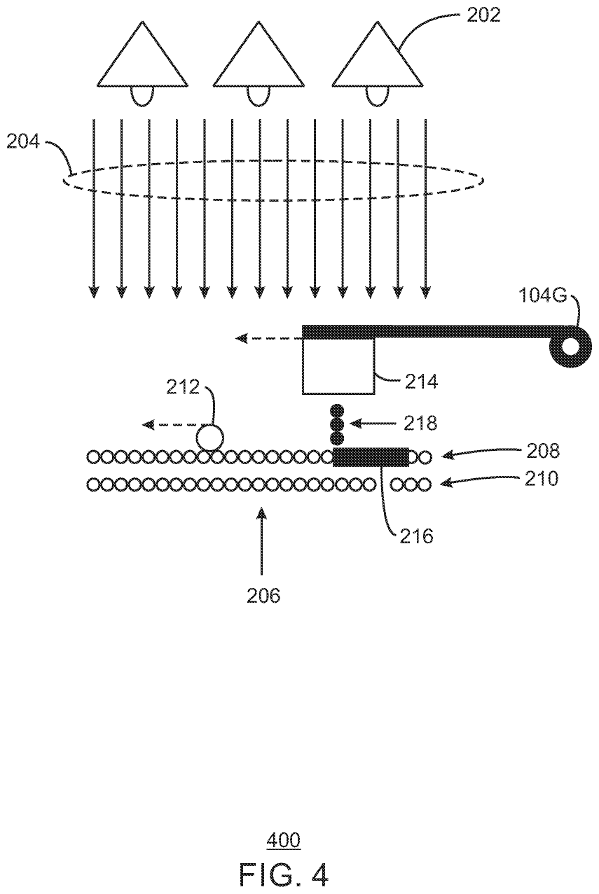

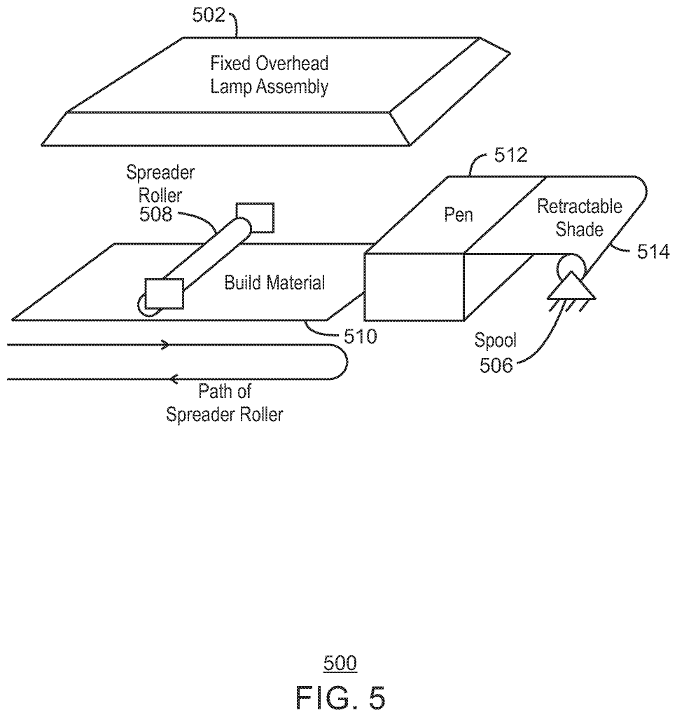

FIG. 5 is a simplified diagram of an additive manufacturing assembly 500 featuring the retractable cover of FIG. 1, according to some examples. A fixed overhead (FOH) lamp assembly 502 is disposed over a top layer 510 of build material. The assembly 500 also includes a spreader roller 508, for spreading the build material uniformly upon the build material layer 510, and a pen 512 for depositing ink or other liquids upon the build material. The pen 512 may be an assembly of inkjets, enabling different colors or types of liquids to be deposited upon the build material.

A retractable shade or cover 514 is connected to the pen 512. In this example, the cover 514 is connected to the right side of the pen 512, which is itself to the right of the build material 510. As the pen 512 moves left over the build material 510, the cover 514 expands to cover any build material to the right of the pen. As the pen 512 moves right over the build material 510, and back to its original position right of the bed, the cover 514 retracts and the cover 504 accumulates upon the spool 506. In this manner, the shade 514 is able to manage emissions from the lamp assembly 502 for more uniform heating/fusing of build material.

The retractable and expandable cover, shade, or shield described herein provides several benefits, in some examples. The cover prevents overheating of the powder on one end of the bed or underheating on the other end of the bed, in some examples. The cover facilitates uniform thermal processing across the length of the bed for various process designs. Although the lamp assemblies described herein are FOH designs, the cover may be useful in scanning additive manufacturing systems as well. By allowing more thermal process design margin, the cover enables use of a wider range of materials, in some examples.

The cover may also be designed for partial shading, to allow enough radiation through to maintain proper powder temperature. In some examples, the cover is made of a material that absorbs heat on a top surface (closer to lamp), and emits longer wavelength infrared light (that is, heat) downward from a bottom surface (closer to build material).

The most desirable process arrangements for FOH systems suffer from temperature differences at each end of the build bed, because fusing illumination occurs sooner and for more time on one end relative to the other, for areas upon which printing agents are deposited. In some examples, scanning lamp systems deliver four heating pulses to the bed per cycle, while FOH systems deliver two heating pulses per cycle. Thus, the heating mismatch between build materials is more severe with FOH systems.

Alternative FOH process designs use single powder spreading passes originating on the side of the printer where the pen is housed may avoid this heating mismatch. However, in some examples, two-pass spreading of build material powder takes place, as improvements in part surface quality is obtained with two-pass spreading.

Additive manufacturing systems that heat on opposite ends of the build bed differently reduce the design margin, limit materials that can be used, limit bed length, and feature tight process controls. The retractable and expandable shade, cover, or shield of FIG. 1 is a possible solution to these issues. In some examples, the cover eliminates or mitigates the temperature differences in the build bed.

In the examples above, the cover is depicted as rolling onto a spool, such as the spool 506 in FIG. 5. However, the cover may comprise a retractable fan or bellows, a sliding shutter, a telescoping shield, as examples.

Further, the retractable and expandable cover may allow a modest measured amount of radiation to pass through, such as to maintain powder temperature before inking and fusing occurs. The cover may be opaque or semi-opaque, transparent, or perforated, depending on the temperature differential being solved. The cover may be opaque to radiation, but deliver warming heat to the freshly spread powder by re-radiating downward at a long infrared wavelength (as a heated object typically radiates). The top surface may have varying degrees of reflectivity, depending on the process design.

And, the cover may be extended to shade the bulge of powder ahead of the spreader roller, and the roller or pen, if desired. In the example assembly 500 (FIG. 5), the shade 504 may extend and cover the spreader roller 508, and extend to the right of the spreader roller, to shade the deposited powder bulge. The cover may also be connected to a brush on the bottom of the shade, such as for cleaning dust when the cover is retracted.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A three-dimensional printer comprising:
a lamp; and
a shade disposed between the lamp and a surface and coupled to one end of a pen, the surface to receive a layer of material, the shade to be selectively opened or retracted in accordance with movement of the pen.

2. The three-dimensional printer of claim 1, wherein the pen is to selectively dispense a liquid agent upon the material.

3. The three-dimensional printer of claim 2, wherein the pen is to move in a first direction over the material, or in a second direction over the material, wherein the second direction is 180 degrees from the first direction.

4. The three-dimensional printer of claim 3, wherein the shade is coupled to the pen and is to be opened in response to the pen moving in the first direction and retracted in response to the pen moving in the second direction.

5. The three-dimensional printer of claim 1, further comprising a roller to spread the material uniformly upon a surface.

6. The three-dimensional printer of claim 5, wherein the shade is to expand in a first direction over the material, or to retract in a second direction over the material, wherein the second direction is 180 degrees from the first direction.

7. The three-dimensional printer of claim 1, wherein the shade is opaque to radiation but re-radiates heat at a long infrared wavelength toward the powder.

8. The three-dimensional printer of claim 1, wherein the shade filters selected wavelengths from reaching the material.

9. The three-dimensional printer of claim 1, wherein the shade is perforated to allow some radiation to pass through.

10. A printer comprising:
a fixed overhead lamp assembly to transmit radiant energy to fuse a build material upon which a fusing agent has been deposited;
a pen comprising one or more print heads to selectively deposit the fusing agent upon the build material; and
a retractable and expandable shade disposed between the fixed overhead lamp assembly and a surface, wherein the surface comprises a first part and a second part;
wherein the shade is to be expanded while the pen moves in a first direction and is to be retracted while the pen moves in a second direction such that the first part and the second part receive similar amounts of radiant energy.

11. The printer of claim 10, wherein the shade is coupled to the pen.

12. The printer of claim 10, further comprising:
a spreader roller to spread build material upon the surface.

13. The printer of claim 10, wherein the retractable and expandable shade is opaque to radiation but re-radiates heat at a long infrared wavelength toward the build material.

14. The printer of claim 10, wherein the shade filters selected wavelengths from reaching the build material.

15. The printer of claim 11, wherein the shade covers the pen to block radiant energy from reaching the pen.
